(19) United States
(12) Patent Application Publication
(10) Pub. No.: US 2021/0065947 A1
(43) Pub. Date: Mar. 4, 2021

(54) MAGNET ASSEMBLY FOR AN ACTUATION AND/OR DELIVERY ASSEMBLY, AND METHOD FOR PRODUCING THE MAGNET ASSEMBLY

(71) Applicant: Robert Bosch GmbH, Stuttgart (DE)

(72) Inventors: Karl-Otto Englert, Gundelsheim (DE); Christoph Waletzek, Ludwigsburg (DE); Peter Boehland, Marbach (DE)

(21) Appl. No.: 16/961,720

(22) PCT Filed: Nov. 26, 2018
(86) PCT No.: PCT/EP2018/082566

§ 371 Date: Jul. 13, 2020

(30) Foreign Application Priority Data
Jan. 11, 2018 (DE) 10 2018 200 382.3

(51) Int. Cl. H01F 7/08; H01F 7/126; H01F 7/16

(52) U.S. Cl. CPC H01F 7/081; H01F 7/1615; H01F 7/126

(57) ABSTRACT

The invention relates to a magnet assembly (1) for an actuation and/or delivery assembly, in particular a delivery pump for an operating medium/additive in a motor vehicle, comprising an annular magnetic coil (2) and a pole body (3) which at least partly engages into the magnetic coil (2) and on which a compression spring (4) is directly or indirectly supported in order to restore an armature (5) that can carry out a stroke movement. According to the invention, the pole body (3) has a magnetic throttle point (6) in a hollow cylindrical section for guiding the armature (5), wherein the magnetic permeability of the pole body (3) is reduced in the region of the throttle point. The invention additionally relates to a method for producing a magnet assembly (1) according to the invention

### BACKGROUND OF THE INVENTION

The invention relates to a magnet assembly for an actuation and/or delivery assembly, in particular a delivery pump for an operating medium/additive in a motor vehicle. For example, the magnet assembly can be used to actuate a closing valve which is integrated into a delivery pump for an operating medium/additive.

Furthermore, the invention relates to a method for producing a magnet assembly according to the invention.

Laid open specification DE 10 2015 226 463 A1 has disclosed a magnetic actuator for a delivery assembly, in particular a diaphragm pump for an operating medium/additive in a vehicle, with an annular magnet coil and a spring-loaded armature. An action can be brought about on the armature by means of the magnet coil in such a way that said armature moves counter to the spring force of the spring which loads it in the direction of a stroke stop which is configured on a return pot, in which the magnet coil is received. Accordingly, guidance of the armature is brought about via the return pot. To this end, the return pot has a section which engages into the annular magnet coil. At the same time, the spring which loads the armature is supported on said section. Further guidance of the armature is brought about via a return collar which likewise engages into the annular magnet coil. In order to prevent a magnetic short circuit between the return pot and the return collar, they are arranged at an axial spacing from one another and are separated from one another by way of an amagnetic material.

The guidance of the armature via the return pot and the return collar requires precise manufacturing and orientation of the two components with respect to one another, in order to ensure optimum armature running. The manufacturing costs rise as a result.

As an alternative, the two components which are manufactured in a separate manner can be welded to one another and reworked, in order to ensure an optimum center axis orientation. The reworking represents additional complexity, however, which again makes the manufacturing more expensive.

### SUMMARY OF THE INVENTION

Proceeding from the abovementioned prior art, the present invention is based on the object of specifying a magnet assembly which makes precise armature running possible and, in addition, can be produced in a comparatively simple and inexpensive manner.

A magnet assembly for an actuation and/or delivery assembly, in particular a delivery pump for an operating medium/additive in a motor vehicle, is proposed which comprises an annular magnet coil and a pole body which engages at least in sections into the magnet coil. Here, a compression spring is supported directly or indirectly on the pole body for restoring an armature which can be moved with a reciprocating motion. According to the invention, the pole body has a magnetic choke point in a hollow-cylindrical section for guiding the armature, in the region of which magnetic choke point the magnetic permeability of the pole body is reduced.

The proposed magnet assembly has the advantage that the pole body can be configured in one piece, with the result that the guidance of the armature is brought about via a single component. Accordingly, a center axis orientation of two separate guide components is not required, in order to ensure optimum armature running. The manufacturing and/or assembly complexity decreases as a result. At the same time, the magnetic choke point ensures that the magnetic field lines lead through the armature and, in this way, provoke the desired build-up of force on the armature and/or the desired movement of the armature.

In order to configure the magnetic choke point, the pole body preferably has a hollow-cylindrical section with a reduced external diameter. On account of the reduced wall thickness, fewer field lines can be guided through, with the result that the magnetic permeability of the pole body decreases in the region of the magnetic choke point. However, limits are set on the reduction of the wall thickness of the pole body in the guide region of the armature, since otherwise the required strength and/or robustness of the pole body are/is no longer ensured.

As an alternative or in addition, it is therefore proposed that the pole body has a hollow-cylindrical section with a modified microstructure in order to configure the magnetic choke point. By way of a modification of the microstructure, the structure of the pole body can be influenced in the relevant region in such a way that fewer field lines are likewise guided through. As a result, the magnetic force of the magnet assembly, which magnetic force acts on the armature, can therefore be increased by up to 40%. At the same time, the wall thickness in the region of the magnetic choke point can be increased again, in order to increase the robustness of the pole body.

In accordance with one preferred embodiment of the invention, in the region of the magnetic choke point, the pole body has a microstructure, into which constituent parts of at least one chemical element, such as nitrogen, are embedded. That is to say, the pole body has been subjected to a treatment with at least one chemical element, in the case of which treatment constituent parts of the chemical element diffuse into the microstructure of the pole body. This leads to the configuration of additional separating layers which reduce the magnetic permeability of the pole body in the region of the magnetic choke point. Here, the magnetic permeability can be influenced in a targeted manner in a manner which is dependent on the wall thickness, the treatment parameters and/or the degree of saturation, particularly thin-walled regions being saturated more rapidly than thick-walled regions. This ensures that a reduction of the magnetic permeability of the pole body is achieved in a targeted manner in the region of the magnetic choke point.

The pole body advantageously protrudes beyond the magnet coil on both sides and/or has a radially outwardly extending annular collar for axially supporting the magnet coil. In this way, the pole body can be used for positional fixing and/or centering of the magnet coil in relation to the armature.

Furthermore, it is proposed that the pole body delimits a coil receptacle space together with a magnetic sleeve which is arranged radially on the outside in relation to the magnet coil and a return ring which is preferably arranged at an end of the pole body, which end lies opposite the annular collar. The magnetic circuit can be closed via the magnetic sleeve and the return ring. At the same time, the magnetic sleeve and the return ring can be supported and/or oriented via the pole body.

The pole body preferably configures a stroke stop for the armature. Accordingly, the stroke of the armature is limited via the pole body. That is to say, the stroke of the armature can be set via the pole body. As an alternative or in addition, the pole body can have a central recess for receiving the compression spring loading the armature in sections. In this way, supporting and/or guidance of the compression spring are/is brought about by way of the pole body.

Moreover, a method for producing a magnet assembly according to the invention is proposed. In the case of said method, the pole body is subjected to a chemical treatment in order to reduce the magnetic permeability in the region of a magnetic choke point. In the case of said treatment, constituent parts of at least one chemical element, such as nitrogen, are embedded into the microstructure of the pole body. For example, the pole body can be loaded with nitrogen, nitrogen diffusing into the microstructure of the pole body and being embedded there. In order to reduce the magnetic permeability of the pole body in the region of the magnetic choke point as far as possible, saturation of the microstructure of the pole body with the at least one chemical element, for example with nitrogen, is aimed for in the region of the magnetic choke point. Since thin-walled regions are saturated more rapidly than thick-walled regions, the saturation can be limited substantially to the region of the magnetic choke point, with the result that the magnetic permeability of the pole body is otherwise not reduced or is not reduced appreciably.

By way of the embedding of the constituent parts of the at least one chemical element into the microstructure of the pole body, additional separating layer, are advantageously configured which reduce the magnetic permeability of the pole body in the region of the magnetic choke point.

The proposed magnet assembly or the magnet assembly which is produced in accordance with the method according to the invention can be used, in particular, as an actuation assembly or actuator, for example in a pump application. Moreover, the magnet assembly can be used as an actuator in any desired applications, for example in a transmission controller.

### BRIEF DESCRIPTION OF THE DRAWINGS

One preferred embodiment of the invention will be described in greater detail in the following text on the basis of the appended drawings, in which:

FIG. 1 shows a diagrammatic longitudinal section through a magnet assembly according to the invention, and

FIG. 2 shows a diagrammatic longitudinal section through the pole body of the magnet assembly from FIG. 1.

### DETAILED DESCRIPTION

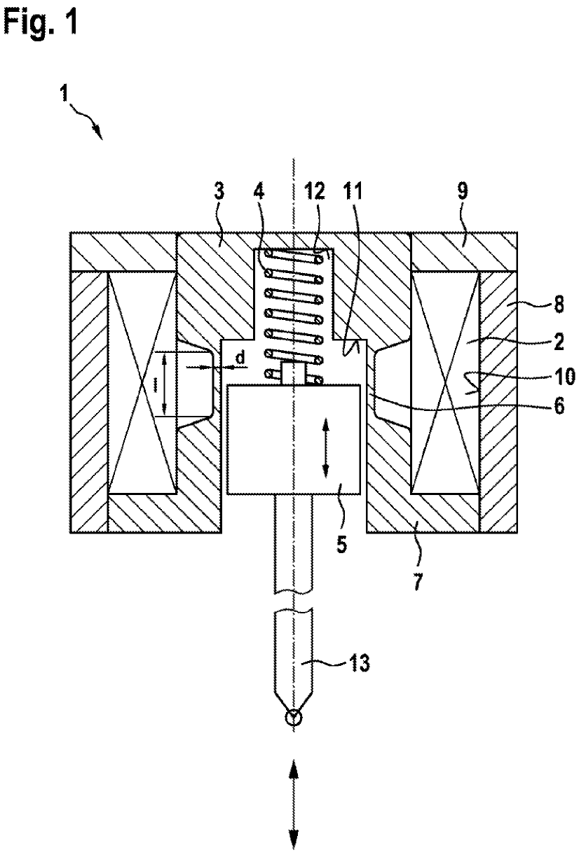

The magnet assembly 1 according to the invention which is shown in FIG. 1 comprises an annular magnet coil 2 which surrounds a pole body 3 which protrudes beyond the magnet coil 2 on both sides. Here, the magnet coil 2 is supported on an annular collar 7 of the pole body 3. The magnet coil 2 is surrounded radially on the outside by a magnetic sleeve 8 which, together with the pole body 3 and a return ring 9, delimits a coil receptacle space 10. To this end, the return ring 9 is placed onto the pole body 3, to be precise on an end of the pole body 3, which end lies opposite the annular collar 7.

The pole body 3 has a hollow-cylindrical section which serves to guide an armature 5 which can be moved with a reciprocating motion. At the same time, the pole body 3 configures a stroke stop 11 for the armature 5. In the region of the stroke stop 11, the pole body 3 has a central recess 12 for receiving a compression spring 4 which is supported at the other end on the armature 5 and serves to restore the armature 5. In this way, the compression spring 4 is also guided by way of the pole body 3.

Offset errors are avoided on account of the guidance of the armature 5 by way of the pole body 3 of single-piece configuration, with the result that optimum armature running is ensured. Furthermore, the manufacturing and/or assembly complexity is decreased. In order at the same time to achieve an optimum build-up of force at the armature 5, the pole body 3 has a magnetic choke point 6 in the region of the hollow-cylindrical section which serves to guide the armature 5. The magnetic choke point 6 is formed by way of a reduced wall thickness and a modified microstructure of the pole body 3. If the hollow-cylindrical section has an external diameter D₁, the latter is reduced in the region of the magnetic choke point 6 to an external diameter D₂. Furthermore, the microstructure of the pole body 3 is modified in the region of the magnetic choke point 6 by way of a chemical treatment. To this end, the pole body 3 has been subjected to a treatment with at least one chemical element 14, such as nitrogen, with the result that constituent parts of the chemical element 14 diffuse into the microstructure of the pole body 3. This leads to the configuration of additional separating layers within the microstructure, which separating layers reduce the magnetic permeability of the pole body 3 in the region of the magnetic choke point 6.

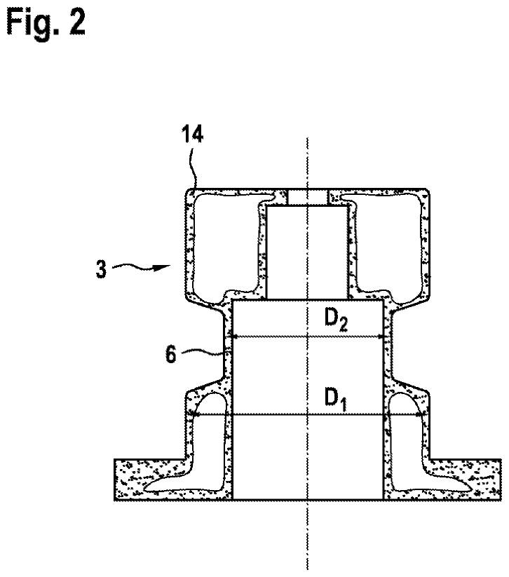

As shown diagrammatically in FIG. 2, the saturation of the microstructure of the pole body 3 with the at least one chemical element 14 is dependent on the wall thickness of the pole body 3. Saturation of thin-walled regions can be brought about more rapidly, with the result that the configuration of additional separating layers can be limited substantially to the region of the magnetic choke point 6. Otherwise, the magnetic permeability of the pole body 3 is accordingly not influenced or not influenced appreciably.

Accordingly, the magnetic force of the magnet assembly 1 according to the invention remains unchanged or rises, since bypass losses are reduced. That is to say, high magnetic forces which act on the armature 5 can be achieved, which magnetic forces can be used, for example, for actuating a valve member 13 which is coupled to the armature 5 (see FIG. 1).

1. A magnet assembly (1) for an actuation and/or delivery assembly, the magnet assembly comprising
an annular magnet coil (2),
a pole body (3) which engages at least in sections into the magnet coil (2), and
a compression spring (4) supported directly or indirectly on the pole body (3) for restoring an armature (5) which can be moved with a reciprocating motion,
wherein the pole body (3) has a magnetic choke point (6) in a hollow-cylindrical section for guiding the armature (5), and wherein the magnetic permeability of the pole body (3) is reduced in a region of the magnetic choke point (6).

2. The magnet assembly (1) as claimed in claim 1, characterized in that, in order to configure the magnetic choke point (6), the pole body (3) has a hollow-cylindrical section with a reduced external diameter (D₂).

3. The magnet assembly (1) as claimed in claim 1, characterized in that, in the region of the magnetic choke point (6), the pole body (3) has a microstructure, into which constituent parts of at least one chemical element are embedded.

4. The magnet assembly (1) as claimed in claim 1, characterized in that the pole body (3) protrudes beyond the magnet coil (2) on both sides.

5. The magnet assembly (1) as claimed in claim 1, characterized in that the pole body (3) delimits a coil receptacle space (10) together with a magnetic sleeve (8) which is arranged radially on an outside in relation to the magnet coil (2) and together with a return ring (9).

6. The magnet assembly (1) as claimed in claim 1, characterized in that the pole body (3) configures a stroke stop (11) for the armature (5).

7. A method for producing a magnet assembly (1) as claimed in claim 1, the method comprising subjecting the pole body (3) to a chemical treatment in order to reduce the magnetic permeability in the region of the magnetic choke point (6), and embedding constituent parts of at least one chemical element (14) into a microstructure of the pole body (3).

8. The method as claimed in claim 7, characterized in that, by way of the embedding of the constituent parts of the at least one chemical element (14) into the microstructure of the pole body (3), additional separating layers are configured which reduce the magnetic permeability of the pole body (3) in the region of the magnetic choke point (6).

9. The magnet assembly (1) as claimed in claim 1, characterized in that, in order to configure the magnetic choke point (6), the pole body (3) has a hollow-cylindrical section with a modified microstructure.

10. The magnet assembly (1) as claimed in claim 9, characterized in that, in order to configure the magnetic choke point (6), the pole body (3) has a hollow-cylindrical section with a reduced external diameter (D₂).

11. The magnet assembly (1) as claimed in claim 1, characterized in that, in the region of the magnetic choke point (6), the pole body (3) has a microstructure, into which constituent parts of nitrogen are embedded.

12. The magnet assembly (1) as claimed in claim 1, characterized in that the pole body (3) has a radially outwardly extending annular collar (7) for axially supporting the magnet coil (2).

13. The magnet assembly (1) as claimed in claim 12, characterized in that the pole body (3) protrudes beyond the magnet coil (2) on both sides.

14. The magnet assembly (1) as claimed in claim 12, characterized in that the pole body (3) delimits a coil receptacle space (10) together with a magnetic sleeve (8) which is arranged radially on an outside in relation to the magnet coil (2) and together with a return ring (9) which is arranged at an end of the pole body (3), which end lies opposite the annular collar (7).

15. The magnet assembly (1) as claimed in claim 1, characterized in that the pole body (3) has a central recess (12) for receiving the compression spring (4) in sections.

16. The magnet assembly (1) as claimed in claim 15, characterized in that the pole body (3) configures a stroke stop (11) for the armature (5).

17. The method as claimed in claim 7, wherein the chemical element (14) is nitrogen.
